(19) United States
(12) Patent Application Publication
(10) Pub. No.: US 2026/0321976 A1
(43) Pub. Date: Oct. 15, 2026

(54) ANTENNA ARRAY STRUCTURE, ANTENNA, AND COMMUNICATION DEVICE

(71) Applicant: HUAWEI TECHNOLOGIES CO., LTD., Shenzhen (CN)

(72) Inventors: Zhenxing WAN, Dongguan (CN); Zijing DU, Xi'an (CN); Huohong CHEN, Kinshasa (CG); Zhi GONG, Dongguan (CN); Chaoyi CHENG, Dongguan (CN)

(73) Assignee: HUAWEI TECHNOLOGIES CO., LTD., Shenzhen (CN)

(21) Appl. No.: 19/699,818

(22) Filed: Jun. 5, 2026

Related U.S. Application Data
(63) Continuation of application No. PCT/CN2024/137130, filed on Dec. 5, 2024.

(30) Foreign Application Priority Data
Dec. 8, 2023 (CN) 202311692454.5

(51) Int. Cl. H01Q 5/378; H01Q 15/14

(52) U.S. Cl. CPC H01Q 5/378; H01Q 15/14

(57) ABSTRACT

This application provides example antenna array structures, example antennas, and example communication devices. One example antenna array structure includes a reflection plate, a first element, and a first parasitic structure, where the reflection plate has a reflective surface, the first element is disposed on a side of the reflective surface, and the first parasitic structure is disposed on a side of the reflective surface and coupled to the first element. Vertical projections of the first parasitic structure and the first element on the reflective surface do not overlap, and a distance between the first parasitic structure and the first element is greater than or equal to 1/4λ, where λ is a wavelength in space of an electromagnetic wave radiated by the first element at the lowest frequency.

### CROSS-REFERENCE TO RELATED APPLICATIONS

This application claims is a continuation of International Application No. PCT/CN2024/137130, filed on Dec. 5, 2024, which priority to Chinese Patent Application No. 202311692454.5, filed on Dec. 8, 2023. The disclosures of the aforementioned applications are hereby incorporated by reference in their entireties.

### TECHNICAL FIELD

This application relates to the field of communication technologies, and in particular, to an antenna array structure, an antenna, and a communication device.

### BACKGROUND

With continuous development of communication technologies, base station antennas are developing toward broadband and miniaturization. For example, a plurality of elements may be disposed in the base station antenna, to improve channel capacity and bandwidth of the base station antenna. Due to space limitation, the distance between adjacent elements is generally small, and this inevitably causes electromagnetic coupling between different elements. Electromagnetic coupling between elements not only increases power loss, but also causes signal distortion, thereby reducing performance of the base station antenna. Therefore, how to reduce the electromagnetic coupling between elements has become a pressing technical challenge.

### SUMMARY

According to a first aspect, this application provides an antenna array structure, including a reflection plate, an element, and a parasitic structure. The reflection plate has a reflective surface, both the element and the parasitic structure are disposed on a side of the reflective surface, and the parasitic structure is coupled to the element. Vertical projections of the parasitic structure and the element on the reflective surface do not overlap, and a distance between the parasitic structure and the element is greater than or equal to 1/4λ, where λ is a wavelength in space of an electromagnetic wave radiated by the element at a lowest frequency. In the antenna array structure provided in this application, the parasitic structure is configured to effectively narrow the beam width, thereby helping improve antenna gain. The parasitic structure is coupled to the element, and an electromagnetic wave radiated by the element may generate an induced current in the parasitic structure, causing the parasitic structure to generate secondary radiation. In addition, because the distance between the parasitic structure and the element is greater than or equal to 1/4λ, the electromagnetic wave radiated by the element and an electromagnetic wave radiated by the parasitic structure can be effectively superimposed, effectively narrowing the beam width of the antenna and increasing the radiation aperture of the antenna, thereby increasing radiation gain of the antenna.

During specific disposition, the distance between the parasitic structure and the element is less than or equal to 3/4λ. To be specific, the distance between the parasitic structure and the element may be any value greater than or equal to 1/4λ and less than or equal to 3/4λ, to ensure effective coupling between the parasitic structure and the element.

In an example, the element and the parasitic structure are located in a same plane, and the plane is parallel to the reflective surface. The element and the parasitic structure are disposed in a same plane, thereby helping reduce a profile height of the antenna array structure and implement a flattened design.

During specific disposition, the antenna array structure includes a plurality of elements and a plurality of parasitic structures. The plurality of elements are coupled to the plurality of parasitic structures in a one-to-one correspondence. The plurality of elements may be disposed to effectively improve signal receiving and sending performance of the antenna array structure. In addition, each element is provided with a correspondingly coupled parasitic structure, effectively narrowing the beam width of the antenna and increasing the radiation aperture of the antenna, thereby increasing radiation gain of the antenna.

In an example, the antenna array structure includes a plurality of elements and at least one parasitic structure. The plurality of elements include a first element and a second element, the second element is an element adjacent to the first element, the at least one parasitic structure includes a first parasitic structure, the first parasitic structure is coupled to the first element, and the first parasitic structure is located on a periphery of the second element. The first parasitic structure may be disposed on the periphery of the second element to effectively improve space utilization, thereby helping dispose more elements and parasitic structures in a limited area.

During specific disposition, the second element and the first parasitic structure are of an integral structure. The integral structure may be disposed to effectively improve integration of the antenna array structure, and improve convenience of manufacturing and assembly.

In an example, the at least one parasitic structure further includes a second parasitic structure. The second parasitic structure is coupled to the second element, and the second parasitic structure is located on a periphery of the first element. The second parasitic structure may be disposed to further increase the radiation aperture of the antenna, thereby increasing the radiation gain of the antenna.

During specific disposition, the first element and the second parasitic structure are of an integral structure. The integral structure may be disposed to effectively improve integration of the antenna array structure, and improve convenience of manufacturing and assembly.

In an example, an equivalent electrical length of the parasitic structure is greater than 1/2λ, to effectively increase the radiation aperture and radiation gain of the antenna. The equivalent electrical length of the parasitic structure is a ratio of a signal wavelength corresponding to an operating frequency of the parasitic structure to π. The equivalent electrical length of the parasitic structure is generally obtained through simulation. The signal wavelength may be considered as λ. In practice, physical size parameters such as a length, a cross-sectional area, and a shape of the parasitic structure are main factors that determine the equivalent electrical length of the parasitic structure. In addition, dielectric strength of the parasitic structure is also a main factor that determines the equivalent electrical length of the parasitic structure.

In an example, the element may be specifically a dual-polarized element. The element includes a first radiating arm and a second radiating arm, and the first radiating arm and the second radiating arm are disposed orthogonally. The parasitic structure includes a first coupling arm and a second coupling arm, and the first coupling arm and the second coupling arm are disposed orthogonally. The first coupling arm is coupled to the first radiating arm, and the second coupling arm is coupled to the second radiating arm.

During specific disposition, the parasitic structure is cross-shaped, and the first coupling arm and the second coupling arm are disposed orthogonally. An included angle between the first radiating arm and the first coupling arm is 0°or 45°. Alternatively, it may be understood that, in practice, a relative spatial posture between the parasitic structure and the element may be flexibly adjusted, to achieve good applicability.

In an example, the parasitic structure is a rectangular frame, a portion of sides of the rectangular frame forms the first coupling arm, and another portion of sides forms the second coupling arm.

In summary, a portion of the parasitic structure coupled to the first radiating arm may be considered as the first coupling arm, and a portion of the parasitic structure coupled to the second radiating arm may be considered as the second coupling arm.

According to a second aspect, this application further provides an antenna, including a feed network and the foregoing antenna array structure, where the feed network is electrically connected to the element for feeding, and is configured to send a feed signal to the element, to excite the element to radiate a radio signal to the outside. In the antenna, the foregoing antenna array structure may be configured to effectively narrow the beam width, thereby helping improve antenna gain. The parasitic structure is coupled to the element, and an electromagnetic wave radiated by the element may generate an induced current in the parasitic structure, so that the parasitic structure generates secondary radiation. In addition, because the distance between the parasitic structure and the element is greater than or equal to 1/4λ, the electromagnetic wave radiated by the element and an electromagnetic wave radiated by the parasitic structure can be effectively superimposed, effectively narrowing the beam width of the antenna and increasing the radiation aperture of the antenna, thereby increasing radiation gain of the antenna.

According to a third aspect, this application further provides a communication device, including a radio frequency processing unit and the foregoing antenna, where the radio frequency processing unit is connected to the feed network. The foregoing antenna may be configured to effectively narrow the beam width, thereby helping improve gain strength of the communication device. The parasitic structure is coupled to the element, and an electromagnetic wave radiated by the element may generate an induced current in the parasitic structure, so that the parasitic structure generates secondary radiation. In addition, because the distance between the parasitic structure and the element is greater than or equal to 1/4λ, the electromagnetic wave radiated by the element and an electromagnetic wave radiated by the parasitic structure can be effectively superimposed, effectively narrowing the beam width of the antenna and increasing the radiation aperture of the antenna, thereby increasing radiation gain of the antenna.

### BRIEF DESCRIPTION OF DRAWINGS

FIG. 1 is a diagram of an application scenario of an antenna according to an embodiment of this application;

FIG. 2 is a diagram of a simplified structure of a base station according to an embodiment of this application;

FIG. 3 is a diagram of a simplified structure of an antenna according to an embodiment of this application;

FIG. 4 is a diagram of a planar structure of an antenna according to an embodiment of this application;

FIG. 5 is a diagram of a side surface structure of an antenna according to an embodiment of this application;

FIG. 6 is another diagram of a side surface structure of an antenna according to an embodiment of this application;

FIG. 7 is another diagram of a side surface structure of an antenna according to an embodiment of this application;

FIG. 8 is another diagram of a side surface structure of an antenna according to an embodiment of this application;

FIG. 9 is another diagram of a planar structure of an antenna according to an embodiment of this application;

FIG. 10 is another diagram of a side surface structure of an antenna according to an embodiment of this application;

FIG. 11 is another diagram of a planar structure of an antenna according to an embodiment of this application;

FIG. 12 is another diagram of a planar structure of an antenna according to an embodiment of this application;

FIG. 13 is another diagram of a planar structure of an element in an antenna according to an embodiment of this application;

FIG. 14 is another diagram of a planar structure of a parasitic structure of an antenna according to an embodiment of this application;

FIG. 15 is another diagram of a planar structure of a parasitic structure of an antenna according to an embodiment of this application;

FIG. 16 is another diagram of a side surface structure of an antenna according to an embodiment of this application;

FIG. 17 is another diagram of a planar structure of an antenna according to an embodiment of this application;

FIG. 18 is another diagram of a planar structure of an antenna according to an embodiment of this application;

FIG. 19 is another diagram of a side surface structure of an antenna according to an embodiment of this application;

FIG. 20 is another diagram of a planar structure of an antenna according to an embodiment of this application;

FIG. 21 is another diagram of a side surface structure of an antenna according to an embodiment of this application;

FIG. 22 is a diagram of a planar structure of a parasitic structure according to an embodiment of this application; and

FIG. 23 is a block diagram of a structure of a communication device according to an embodiment of this application.

### DESCRIPTION OF EMBODIMENTS

To make the objectives, technical solutions, and advantages of this application clearer, the following further describes this application in detail with reference to the accompanying drawings.

To facilitate understanding of an antenna provided in embodiments of this application, the following first describes an application scenario of the antenna.

The antenna provided in embodiments of this application may be used in a communication device like a base station or a radar, to implement a wireless communication function.

As shown in FIG. 1, an application scenario may include a base station and a terminal. Wireless communication can be implemented between the base station and the terminal. The base station may be located in a base station subsystem (base station subsystem, BBS), a terrestrial radio access network (UMTS terrestrial radio access network, UTRAN), or an evolved terrestrial radio access network (evolved universal terrestrial radio access network, E-UTRAN), and is configured to provide cell coverage of a radio signal, to implement communication between a terminal device and a wireless network. Specifically, the base station may be a base transceiver station (base transceiver station, BTS) in a global system for mobile communications (global system for mobile communications, GSM) or a code division multiple access (code division multiple access, CDMA) system, or may be a NodeB (NodeB, NB) in a wideband code division multiple access (wideband code division multiple access, WCDMA) system, or may be an evolved NodeB (evolved NodeB, eNB or eNodeB) in a long term evolution (long term evolution, LTE) system, or may be a radio controller in a cloud radio access network (cloud radio access network, CRAN) scenario. Alternatively, the base station may be a relay station, an access point, a vehicle-mounted device, a wearable device, a gNodeB (gNodeB or gNB) in a new radio (new radio, NR) system, a base station in a future evolved network, or the like. This is not limited in embodiments of this application.

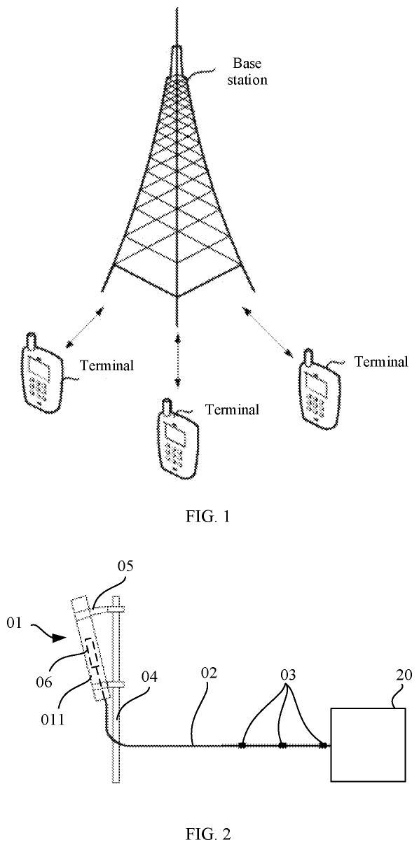

In this application, the antenna may also be used in an access network device, and the access network device is sometimes referred to as an access node. The access network device has a wireless transceiver function, and is configured to communicate with a terminal. The access network device includes but is not limited to a base station (base station) in the foregoing communication system, an evolved NodeB (evolved NodeB, eNodeB), a transmission reception point (transmission reception point, TRP), a next generation NodeB (next generation NodeB, gNB) in a 5G mobile communication system, a next generation base station in a 6th generation (6th generation, 6G) mobile communication system, an access network device or a module of the access network device in an open access network ORAN (open RAN, ORAN) system, a base station in a future mobile communication system, an access node in a Wi-Fi system, or the like. Alternatively, the access network device may be a module or a unit that can implement some functions of a base station. For example, the access network device may be a central unit (central unit, CU), a distributed unit (distributed unit, DU), a CU-control plane (control plane, CP), a CU-user plane (user plane, UP), a radio unit (radio unit, RU), or the like described below. In the ORAN system, the CU may also be referred to as an O-CU, the DU may also be referred to as an open (open, O)-DU, the CU-CP may also be referred to as an O-CU-CP, the CU-UP may also be referred to as an O-CU-UP, and the RU may also be referred to as an O-RU. The access network device may be a macro base station (for example, 110a in FIG. 2), a micro base station or an indoor station (for example, 110b in FIG. 2), a relay node, a donor node, or a radio controller in a cloud radio access network (cloud radio access network, CRAN) scenario. Optionally, the access network device may alternatively be a server, a wearable device, a vehicle-mounted device, or the like. For example, an access network device in a vehicle-to-everything (vehicle-to-everything, V2X) technology may be a road side unit (road side unit, RSU). A plurality of access network devices in the communication system may be base stations of a same type, or may be base stations of different types. The base station may communicate with the terminal, or may communicate with the terminal via a relay station. The terminal may communicate with a plurality of base stations in different access technologies.

As shown in FIG. 2, a base station provided in embodiments of this application includes a base station antenna feeder system. In practice, the base station antenna feeder system mainly includes an antenna 01, a feeder 02, a grounding apparatus 03, and the like. The antenna 01 is generally fastened to a pole 04, and a downtilt of the antenna 01 may be adjusted through an antenna adjustment mounting bracket 05, to adjust a signal coverage area of the antenna 01 to a specific extent.

In addition, the base station may further include a radio frequency processing unit 06 and a baseband processing unit 20. For example, the radio frequency processing unit 06 may be configured to: perform frequency selection, amplification, and down-conversion on a signal received by the antenna 01; convert the signal into an intermediate frequency signal or a baseband signal; and send the intermediate frequency signal or the baseband signal to the baseband processing unit 20. Alternatively, the radio frequency processing unit 06 is configured to: perform up-conversion and amplification on an intermediate frequency signal sent by the baseband processing unit 20, convert the intermediate frequency signal into a radio signal, and send the radio signal through the antenna 01. The baseband processing unit 20 may be connected to a feed network of the antenna 01 through the radio frequency processing unit 06. In some implementations, the radio frequency processing unit 06 may also be referred to as a remote radio unit (remote radio unit, RRU), and the baseband processing unit 20 may also be referred to as a baseband unit (baseband unit, BBU).

As shown in FIG. 2, in a possible embodiment, the radio frequency processing unit 06 may be integrated with the antenna 01, the baseband processing unit 20 is located remotely from the antenna 01, and the radio frequency processing unit 06 may be connected to the baseband processing unit 20 through the feeder 02. In another embodiment, both the radio frequency processing unit 06 and the baseband processing unit 20 may alternatively be located remotely from the antenna 01.

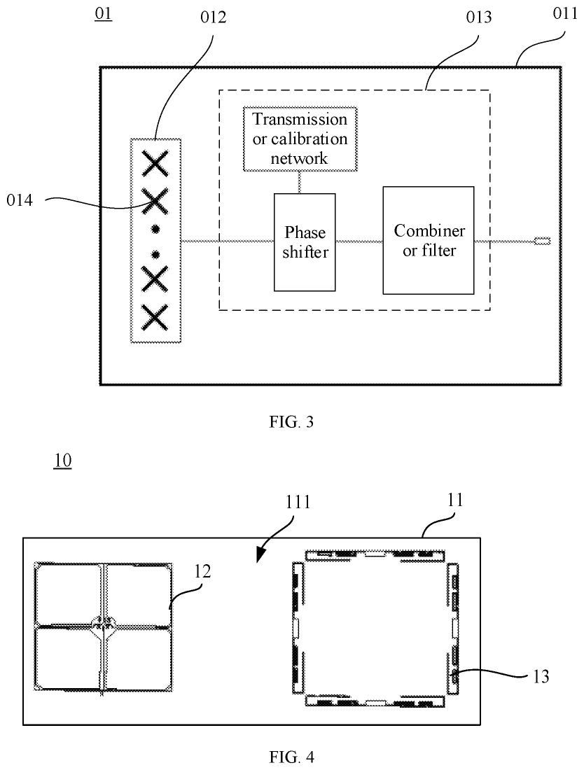

Refer to FIG. 2 and FIG. 3. The antenna 01 used in the base station may further include a radome 011, and a reflection plate 012 and a feed network 013 that are located in the radome 011. The reflection plate 012 may also be referred to as a bottom plate. A main function of the feed network 013 is to feed a signal to a radiation component 014 based on a specific amplitude and phase, or send a radio signal received by the radiation component 014 to the baseband processing unit 20 of the base station based on a specific amplitude and phase. It may be understood that, in a specific implementation, the feed network 013 may include at least one of devices such as a phase shifter, a combiner, a transmission or calibration network, or a filter. Components and types of the feed network 013 and functions that can be implemented by the feed network 013 are not limited in this application.

Certainly, the antenna 01 may be further used in a plurality of other types of communication devices. An application scenario of the antenna 01 is not limited in this application.

For the radome 011, in terms of electrical performance, the radome 011 has good electromagnetic wave penetrability, so that normal sending and receiving of an electromagnetic wave between the radiation component 014 and the outside are not affected. In terms of mechanical performance, the radome 011 has good force-bearing performance, anti-oxidation performance, and the like, so that the radome 011 can withstand corrosion of an external harsh environment.

The radiation component 014 may also be referred to as an element, and is a unit that forms a basic structure of an antenna. The radiation component 014 can effectively transmit or receive an electromagnetic wave. The radiation component 014 may include a plurality of elements, and the plurality of elements may also form an array for use. During specific application, the elements may be classified into a single-polarization type, a dual-polarization type, and the like. During specific configuration, a type of the element may be properly selected according to an actual requirement.

With continuous development of mobile communication technologies, a 5th generation mobile communication technology (5th generation mobile communication technology, 5G) is also widely applied. As one of key technologies of a 5G communication system, a massive multiple-input multiple-output (multiple-input multiple-output, MIMO) technology can effectively increase channel capacity. In the background of the multiple-input multiple-output technology, a large quantity of elements need to be arranged in an antenna. In addition, on a premise of a miniaturization design, an effective aperture of the antenna is reduced, and coupling between the elements is obvious. An antenna pattern is prone to distortion, and an antenna gain is reduced.

Therefore, an embodiment of this application provides an antenna that can effectively narrow the beam width and achieve large radiation gain.

To make objectives, technical solutions, and advantages of this application clearer, the following further describes this application in detail with reference to the accompanying drawings and specific embodiments.

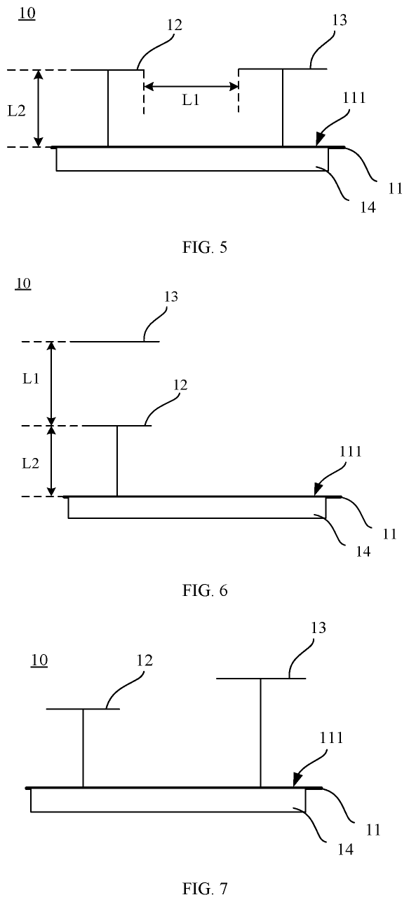

As shown in FIG. 4 and FIG. 5, in an example provided in this application, the antenna array structure in the antenna 10 includes a reflection plate 11, an element 12, and a parasitic structure 13. The reflection plate 11 has a reflective surface 111, and both the element 12 and the parasitic structure 13 are disposed on a side of the reflective surface 111. The parasitic structure 13 is coupled to the element 12, and an electromagnetic wave radiated by the element 12 may generate an induced current in the parasitic structure 13, to excite the parasitic structure 13 to generate secondary radiation. Vertical projections of the parasitic structure 13 and the element 12 on the reflective surface 111 do not overlap, and a distance between the parasitic structure 13 and the element 12 is greater than or equal to 1/4λ, where λ is a wavelength in space of an electromagnetic wave radiated by the element 12 at a lowest frequency. It should be noted that the parasitic structure 13 is a conductive structure that has a parasitic relationship with the element 12, and the parasitic structure 13 generates secondary radiation depending on an electromagnetic wave generated by the element 12. Specifically, when the electromagnetic wave generated by the element 12 passes through the parasitic structure 13, an electric field component in the electromagnetic wave causes a movement of an electric charge in the parasitic structure 13, and an induced current is generated in the parasitic structure 13, to generate secondary radiation.

In the example provided in this application, the parasitic structure 13 is configured in the antenna 10 to effectively narrow the beam width, thereby helping improve gain of the antenna 10. Specifically, in the example provided in this application, the element 12 is an active element 12. The feed network 14 may be disposed on a side of the reflection plate 11 away from the reflective surface 111. The feed network 14 is connected to the element 12 and is configured to send a feed signal to the element 12, so that the element 12 radiates an electromagnetic wave to the outside. The parasitic structure 13 is coupled to the element 12, and an electromagnetic wave radiated by the element 12 may generate an induced current in the parasitic structure 13, so that the parasitic structure 13 generates secondary radiation. In addition, because the distance between the parasitic structure 13 and the element 12 is greater than or equal to 1/4λ, the electromagnetic wave radiated by the element 12 and an electromagnetic wave radiated by the parasitic structure 13 can be effectively superimposed, effectively narrowing the beam width of the antenna 10 and increasing the radiation aperture of the antenna 10, thereby increasing radiation gain of the antenna 10.

In addition, in the example provided in this application, vertical projections of the element 12 and the parasitic structure 13 on the reflective surface 111 do not overlap, so that a profile height of the antenna 10 can be effectively reduced, and a flattened design of the antenna 10 can be implemented.

Specifically, as shown in FIG. 6, when the vertical projections of the element 12 and the parasitic structure 13 on the reflective surface 111 overlap, the distance between the element 12 and the parasitic structure 13 is L1, and in a direction perpendicular to the reflective surface 111, the distance between the element 12 and the parasitic structure 13 is also L1. If the distance between the element 12 and the reflective surface 111 is L2, the profile height of the antenna 10 is approximately L1+L2.

As shown in FIG. 5, when the vertical projections of the element 12 and the parasitic structure 13 on the reflective surface 111 do not overlap, the distance between the element 12 and the parasitic structure 13 is L1. In the direction perpendicular to the reflective surface 111, if the distance between the element 12 and the parasitic structure 13 is approximately zero, and the distance between the element 12 and the reflective surface 111 is L2, the profile height of the antenna 10 is approximately L2. Therefore, the vertical projections of the element 12 and the parasitic structure 13 on the reflective surface 111 do not overlap, so that the profile height of the antenna 10 can be effectively reduced, and a flattened design of the antenna 10 can be implemented.

During specific disposition, the distance between the element 12 and the parasitic structure 13 may be further less than 3/4λ, to ensure a coupling effect between the element 12 and the parasitic structure 13. In other words, the distance between the element 12 and the parasitic structure 13 may be any value between 1/4λ and 3/4λ. For example, the distance between the element 12 and the parasitic structure 13 may be specifically 1/4λ, 2/5λ, 1/2λ, 3/5λ, 3/4λ, or the like. During specific application, the distance between the element and the parasitic structure 13 may be properly selected and set according to an actual requirement. Details are not described herein.

It should be noted that, in the example provided in FIG. 5, the element 12 and the parasitic structure 13 are approximately located in a same plane, and the plane is parallel to the reflective surface 111. However, in practice, the element 12 and the parasitic structure 13 may alternatively be located in different planes. In other words, in the direction perpendicular to the reflective surface 111, there may be a height deviation between the element 12 and the parasitic structure 13.

In addition, during specific disposition, an equivalent electrical length of the parasitic structure 13 may be greater than 1/2λ, to effectively increase the radiation aperture and radiation gain of the antenna 10. During specific disposition, an equivalent electrical length of the parasitic structure 13 may be specifically 3/5λ, 4/5λ, λ, 2λ, or the like. In practice, the equivalent electrical length of the parasitic structure 13 may be properly set according to an actual requirement. Details are not described herein. It should be noted that the distance between the parasitic structure 13 and the element 12 is related to a wavelength λ in space of an electromagnetic wave radiated by the element 12 at a lowest frequency, and the equivalent electrical length of the parasitic structure 13 is also related to the wavelength λ in space of the electromagnetic wave radiated by the element 12 at the lowest frequency. Therefore, in practice, the distance between the parasitic structure 13 and the element 12 and the equivalent electrical length of the parasitic structure 13 may be properly set based on λ.

It should be noted that the equivalent electrical length of the parasitic structure 13 is a ratio of a signal wavelength corresponding to an operating frequency of the parasitic structure 13 to T. The equivalent electrical length of the parasitic structure 13 is generally obtained through simulation. The signal wavelength may be considered as λ. In practice, physical size parameters such as a length, a cross-sectional area, and a shape of the parasitic structure 13 are main factors that determine the equivalent electrical length of the parasitic structure 13. In addition, dielectric strength of the parasitic structure 13 is also a main factor that determines the equivalent electrical length of the parasitic structure 13. During specific disposition, parameters such as the physical size and the dielectric strength of the parasitic structure 13 may be properly set according to an actual requirement. Details are not described herein.

In addition, during specific disposition, there may be various relative positions between the element 12 and the parasitic structure 13.

For example, as shown in FIG. 7, in an example provided in this application, the parasitic structure 13 is located on a side of the element 12 away from the reflective surface 111.

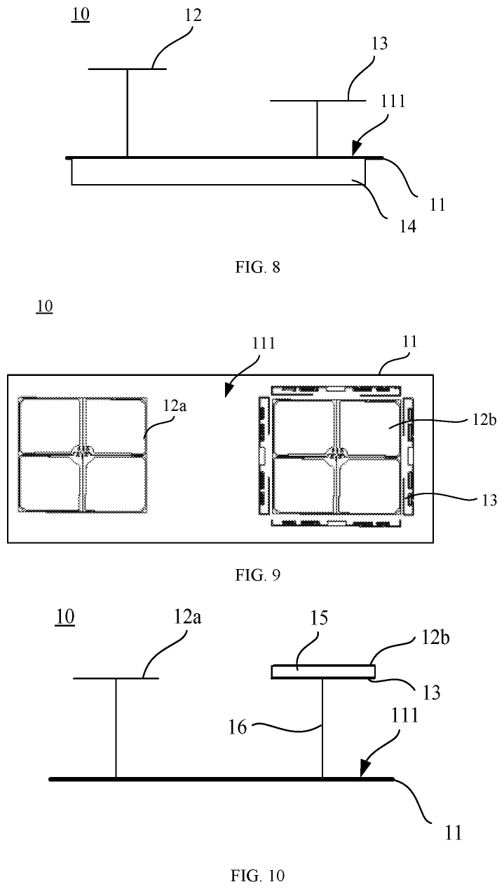

Alternatively, as shown in FIG. 8, in another example provided in this application, the parasitic structure 13 is located on a side of the element 12 close to the reflective surface 111.

Alternatively, as shown in FIG. 5, in an example provided in this application, the parasitic structure 13 and the element 12 are located in a same plane, and the plane is approximately parallel to the reflective surface 111. It should be noted that, that the parasitic structure 13 and the element 12 are located in a same plane means that the parasitic structure 13 and the element 12 are approximately located in the same plane. In other words, in the direction perpendicular to the reflective surface 111, there is no height difference between the parasitic structure 13 and the element 12, or there is a small height difference. This position layout helps improve an integrated design of the antenna 10.

For example, in practice, the antenna 10 may include a plurality of elements 12, and the parasitic structure 13 may be integrated with one of the elements 12.

To facilitate understanding of the technical solutions in this application, the following uses an example in which the antenna 10 includes two elements for description. In addition, for ease of differentiation, one of the two elements is defined as a first element 12a, and the other is defined as a second element 12b.

Specifically, as shown in FIG. 9, the antenna 10 includes the first element 12a and the second element 12b, where the first element 12a and the second element 12b are two adjacent elements. The parasitic structure 13 is coupled to the first element 12a, the first element 12a, the second element 12b, and the parasitic structure 13 are located in a same plane, and the parasitic structure 13 is located on a periphery of the second element 12b.

During specific application, the parasitic structure 13 and the second element 12b may be prepared in an integrated manner, so that preparation costs of the antenna 10 can be effectively reduced, a process procedure can be simplified, and integration of the antenna 10 can also be improved.

In terms of a structure type, the second element 12b and the parasitic structure 13 may be formed by using a printed circuit board (printed circuit board, PCB) or a flexible circuit board (flexible printed circuit board, FPC). Specifically, a conductive structure may be disposed in the printed circuit board or the flexible circuit board, to form the second element 12b and the parasitic structure 13. During preparation, a currently mature process may be used to prepare a circuit board, thereby achieving low preparation costs and high reliability.

For example, as shown in FIG. 10, the second element 12b and the parasitic structure 13 are formed by using a printed circuit board. The second element 12b and the parasitic structure 13 are respectively located on two plate surfaces of a dielectric substrate 15. It should be noted that, in the example provided in FIG. 10, to facilitate displaying of the second element 12b and the parasitic structure 13, the second element 12b and the parasitic structure 13 are respectively located on two plate surfaces of the dielectric substrate 15. However, in practice, the second element 12b and the parasitic structure 13 may alternatively be located on a same plate surface of the dielectric substrate 15. Details are not described herein.

Alternatively, in another example, the second element 12b and the parasitic structure 13 may be sheet metal parts. For example, the second element 12b and the parasitic structure 13 may be formed by using a process such as stamping or cutting. Certainly, it should be noted that, to prevent a short circuit between the second element 12b and the parasitic structure 13, electrical insulation needs to be maintained between the second element 12b and the parasitic structure 13. During specific disposition, the second element 12b and the parasitic structure 13 may be processed by using an insulating bracket or a process such as secondary injection molding, to fasten the second element 12b and the parasitic structure 13 into an integral structure.

In addition, the integral structure is disposed to help reduce a quantity of connectors used and simplify an assembly process.

Specifically, as shown in FIG. 10, in practice, the second element 12b and the parasitic structure 13 may be fastened together to the reflection plate 11 by using a connector like an insulating bracket 16. To be specific, the second element 12b and the parasitic structure 13 may be fastened to the reflection plate 11 by using a same connector, so that a quantity of connectors used can be reduced, and an assembly process procedure of the antenna 10 can also be simplified.

It may be understood that, in another example, the second element 12b and the parasitic structure 13 may alternatively be two independent mechanical parts, in other words, the second element 12b and the parasitic structure 13 may not be fastened to each other. In addition, the second element 12b and the parasitic structure 13 may alternatively be fastened to the reflection plate 11 by using different connectors. Details are not described herein.

Additionally, in practice, a parasitic structure coupled to the second element 12b may also be disposed in the antenna 10, to further increase radiation gain of the antenna 10.

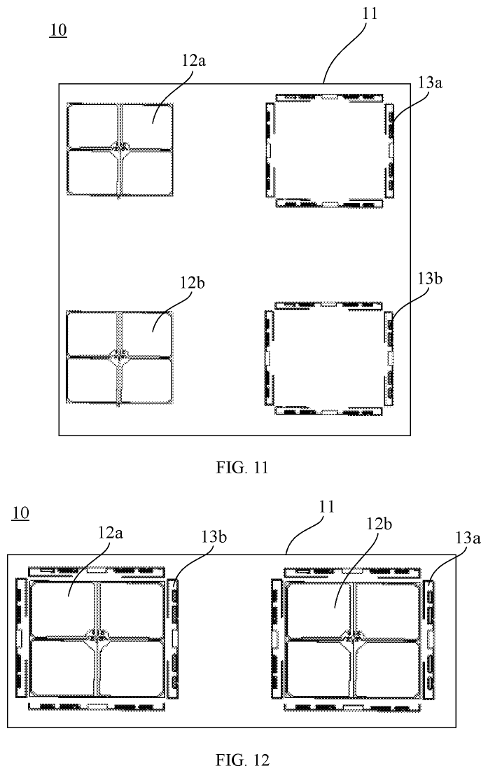

For example, as shown in FIG. 11, in an example provided in this application, the antenna 10 includes two parasitic structures: a parasitic structure 13a and a parasitic structure 13b. The parasitic structure 13a is coupled to the first element 12a, and the parasitic structure 13b is coupled to the second element 12b. Alternatively, it may be understood that a distance between the parasitic structure 13 a and the first element 12 a may be any value between 1/4λa and 3/4λa, where Na is a wavelength in space of an electromagnetic wave radiated by the first element 12a at a lowest frequency, to ensure effective coupling between the parasitic structure 13a and the first element 12a. In addition, the distance between the parasitic structure 13b and the second element 12b may be any value between 1/4λb and 3/4λb, where 2b is a wavelength in space of an electromagnetic wave radiated by the second element 12b at a lowest frequency, to ensure effective coupling between the parasitic structure 13b and the second element 12b.

It should be noted that, in practice, operating frequency bands of the first element 12a and the second element 12b may be the same or different. During specific setting, the operating frequency bands of the first element 12a and the second element 12b may be properly set according to an actual requirement. Details are not described herein.

It may be understood that, in the foregoing example, an example in which the antenna 10 includes two parasitic structures and two elements is used for description. In practice, the antenna 10 may include more than two elements and more than two parasitic structures, and each element is equipped with a parasitic structure that is correspondingly coupled. In summary, the antenna 10 may include a plurality of elements and a plurality of parasitic structures, and the plurality of elements are coupled to the plurality of parasitic structures in a one-to-one correspondence.

In addition, in the example provided in FIG. 11, both the element and the parasitic structure are independent mechanical parts, and are separately and independently disposed on a side of the reflection plate 11.

In another example, the element and the parasitic structure may alternatively be integrated.

For example, as shown in FIG. 12, in an example provided in this application, two elements and two parasitic structures are shown. Specifically, the two elements are respectively the first element 12a and the second element 12b. The two parasitic structures are respectively the parasitic structure 13a and the parasitic structure 13b. The parasitic structure 13a is coupled to the first element 12a, and the parasitic structure 13b is coupled to the second element 12b. In addition, the first element 12a and the parasitic structure 13b are integrated, and the second element 12b and the parasitic structure 13a are integrated.

During specific disposition, specific structure types of the first element 12a, the second element 12b, the parasitic structure 13a, and the parasitic structure 13b may be properly selected and adjusted based on an actual situation. In addition, an integration manner between the first element 12a and the parasitic structure 13b and an integration manner between the second element 12b and the parasitic structure 13a may also be properly set according to an actual requirement.

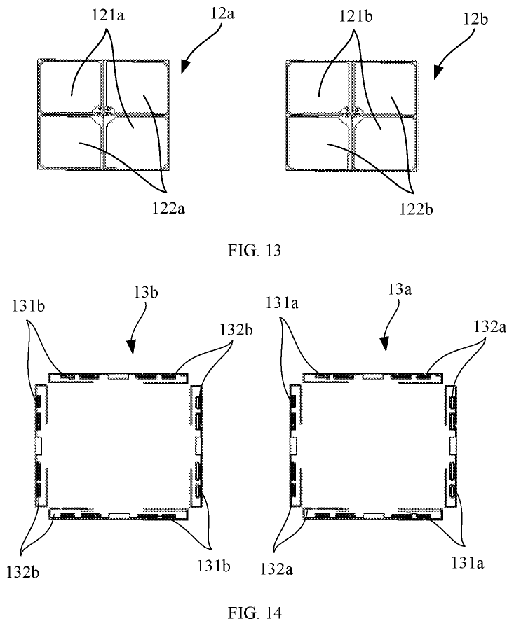

For example, as shown in FIG. 12 and FIG. 13, in an example provided in this application, both the first element 12a and the second element 12b are dual-polarized elements.

Specifically, the first element 12a includes a first radiating arm 121a and a second radiating arm 122a that are orthogonally disposed. The first radiating arm 121a and the second radiating arm 122a may radiate or receive electromagnetic waves in different polarization directions, and have good signal receiving and transmitting performance. Correspondingly, the second element 12b includes a first radiating arm 121b and a second radiating arm 122b that are orthogonally disposed. The first radiating arm 121b and the second radiating arm 122b may radiate or receive electromagnetic waves in different polarization directions, and have good signal receiving and transmitting performance.

As shown in FIG. 12 and FIG. 14, both the parasitic structure 13a and the parasitic structure 13b are rectangular frame structures. A corner 131a of the parasitic structure 13a is coupled to the first radiating arm 121a, and a corner 132a of the parasitic structure 13a is coupled to the second radiating arm 122a. Correspondingly, a corner 131b of the parasitic structure 13b is coupled to the first radiating arm 121b, and a corner 132b of the parasitic structure 13b is coupled to the second radiating arm 122b.

During specific disposition, the first element 12a and the parasitic structure 13b may be located in a same plane, and the parasitic structure 13b is located on a periphery of the first element 12a. The second element 12b and the parasitic structure 13a may be located in a same plane, and the parasitic structure 13a is located on a periphery of the second element 12b.

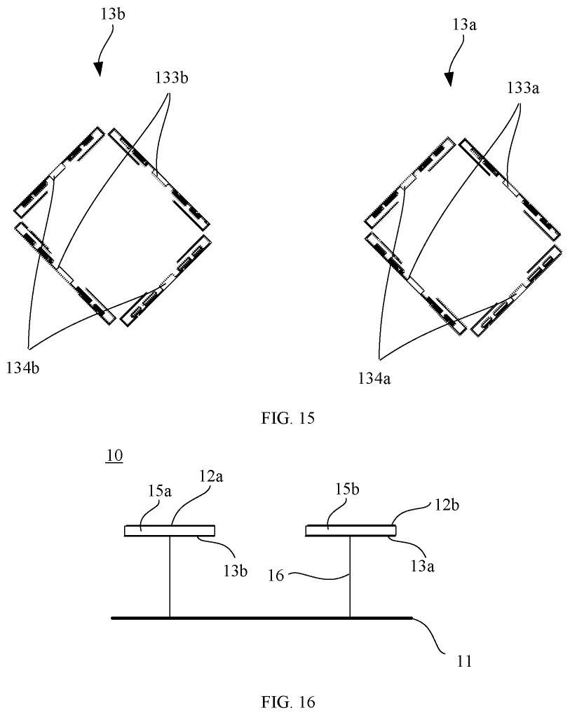

In addition, as shown in FIG. 15, in comparison with the example shown in FIG. 14, in another example provided in this application, the parasitic structure 13a and the parasitic structure 13b have different spatial postures. Alternatively, it may be understood that, in the structure shown in FIG. 15, it may be considered that the parasitic structure 13a and the parasitic structure 13b shown in FIG. 14 are formed by rotating the parasitic structure 13a and the parasitic structure 13b counterclockwise by about 45°, and the first element 12 a and the second element 12 b may not be adjusted.

Specifically, refer to FIG. 13 and FIG. 15. In the example provided in FIG. 15, an edge 133a of the parasitic structure 13a is coupled to the first radiating arm 121a, and an edge 134a of the parasitic structure 13a is coupled to the second radiating arm 122a. Correspondingly, an edge 133b of the parasitic structure 13b is coupled to the first radiating arm 121b, and an edge 134b of the parasitic structure 13b is coupled to the second radiating arm 122b.

In addition, in the example provided in FIG. 15, limited by a size and a shape, space enclosed by the parasitic structure 13a may be insufficient to accommodate the second element 12b, and space enclosed by the parasitic structure 13b may be insufficient to accommodate the first element 12a. Therefore, when the parasitic structure 13a and the second element 12b are integrated, the parasitic structure 13a and the second element 12b may be disposed in layers. Correspondingly, when the parasitic structure 13b and the first element 12a are integrated, the parasitic structure 13b and the first element 12a may be disposed in layers.

For example, as shown in FIG. 16, in an example provided in this application, the first element 12a may be located on an upper plate surface of the dielectric substrate 15a, and the parasitic structure 13b may be located on a lower plate surface of the dielectric substrate 15a. In this way, the first element 12a of the parasitic structure and the parasitic structure 13b can be integrated. The second element 12b may be located on the upper surface of the dielectric substrate 15b, and the parasitic structure 13a may be located on the lower surface of the dielectric substrate 15b. In this way, the second element 12b of the parasitic structure and the parasitic structure 13a can be integrated.

In addition, in the foregoing example, an example in which both the parasitic structure 13a and the parasitic structure 13b are rectangular frame structures is used for description.

In another example, the parasitic structure 13a and the parasitic structure 13b may alternatively be in other shapes.

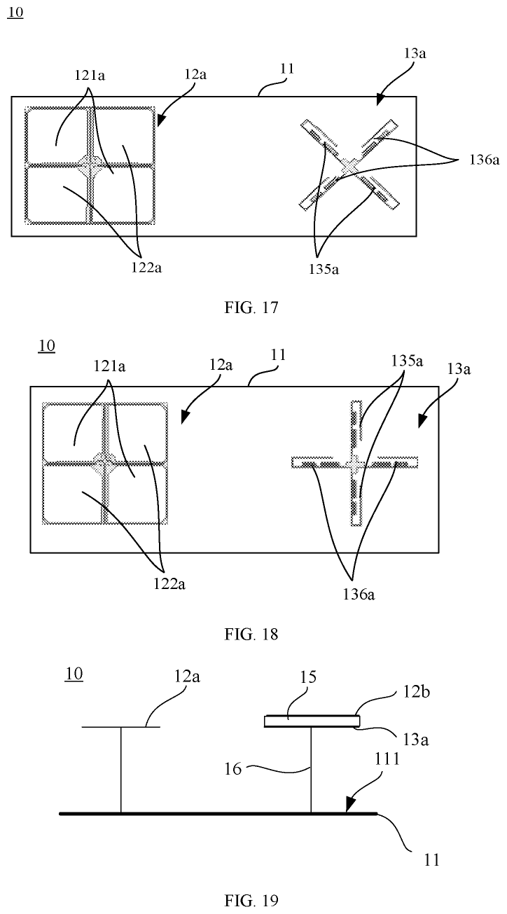

For example, as shown in FIG. 17, the parasitic structure 13a is used as an example. In another example provided in this application, the parasitic structure 13a is cross-shaped. Specifically, the parasitic structure 13a includes a first coupling arm 135a and a second coupling arm 136a that are orthogonally disposed. An extension direction of the first coupling arm 135a is consistent with an extension direction of the first radiating arm 121a, to effectively couple the first coupling arm 135a and the first radiating arm 121a. An extension direction of the second coupling arm 136a is consistent with an extension direction of the second radiating arm 122a, to effectively couple the second coupling arm 136a and the second radiating arm 122a.

Alternatively, as shown in FIG. 18, in another example provided in this application, it may be considered that the parasitic structure 13a is formed by counterclockwise rotating the parasitic structure 13a shown in FIG. 17 by about 45°. In this case, the parasitic structure 13a and the first element 12a can still be effectively coupled.

In summary, in practice, spatial postures of the parasitic structure 13a and the first element 12a may be flexibly set according to an actual situation. Details are not described herein.

It should be noted that, when the parasitic structure 13b is disposed, the parasitic structure 13b may be similarly disposed in combination with a specific structure of the parasitic structure 13a. Details are not described herein.

Additionally, in practice, the cross-shaped parasitic structure 13a and the second element 12b may alternatively be integrated.

For example, as shown in FIG. 19, in an example provided in this application, the parasitic structure 13a and the second element 12b may be disposed in layers. Specifically, the parasitic structure 13a may be located on a lower plate surface of the dielectric substrate, and the second element 12b may be located on an upper plate surface of the dielectric substrate, so that the parasitic structure 13a and the second element 12b can be integrated.

It should be noted that, in the foregoing example, an example in which the element 12 is a dual-polarized element is used for description. In practice, the element 12 may alternatively be a single-polarized element or the like. A specific type of the element 12 is not limited in this application.

Additionally, in practice, the antenna 10 may include a plurality of elements 12, and the plurality of elements may be arranged in an array.

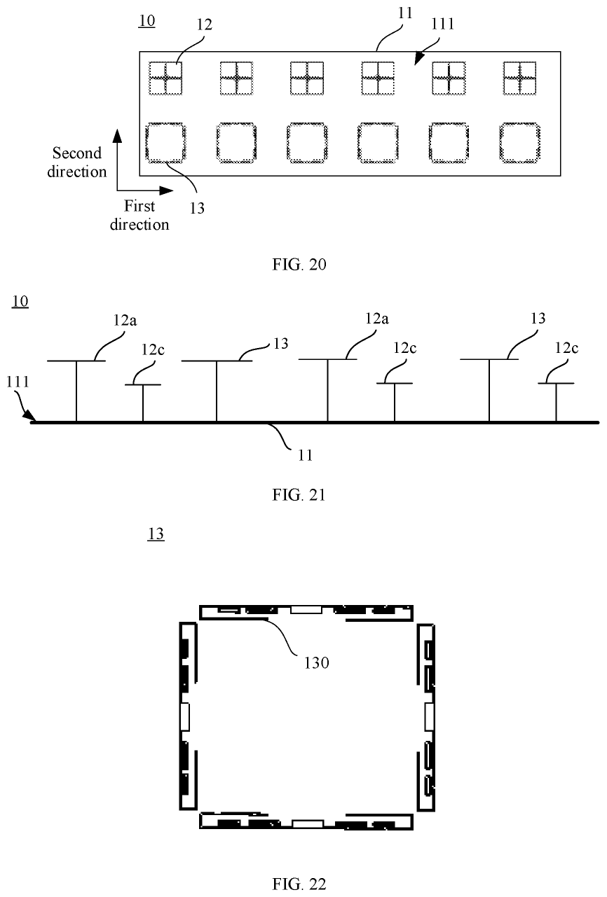

For example, as shown in FIG. 20, in an example provided in this application, the antenna 10 may include six elements 12, and the six elements 12 are sequentially spaced apart in a first direction. In addition, the antenna 10 further includes six parasitic structures 13, and the six parasitic structures 13 are sequentially spaced apart in the first direction. In a second direction, the elements 12 are coupled to the parasitic structures 13 in a one-to-one correspondence. The first direction is perpendicular to the second direction, and both the first direction and the second direction are parallel to the reflective surface 111.

In another example, more elements 12 and parasitic structures 13 may alternatively be disposed in the second direction. In practice, parameters such as a quantity and positions of the elements 12 and the parasitic structures 13 may be properly set according to an actual requirement. This is not limited in this application.

Additionally, in practice, operating frequency bands of the elements 12 in the antenna 10 may be basically the same. Alternatively, elements 12 of different operating frequency bands may be disposed in the antenna 10.

For example, as shown in FIG. 21, in an example provided in this application, the antenna 10 includes elements of two different frequency bands: an element 12a and an element 12c. Operating frequency bands of the element 12a are basically the same, operating frequency bands of the element 12c are basically the same, and the operating frequency band of the element 12c is greater than the operating frequency band of the element 12a.

Additionally, in practice, to avoid affecting performance of the element 12c due to coupling between the parasitic structure 13 and the element 12c, in practice, a decoupling structure may be disposed in the parasitic structure 13, to reduce or avoid coupling with the element 12c.

For example, as shown in FIG. 22, in an example provided in this application, the parasitic structure 13 includes a bent decoupling stub 130. The decoupling stub 130 may be disposed to reduce or avoid coupling between the parasitic structure and the element 12c. During specific disposition, structure shapes and a quantity of decoupling stubs 130 may be properly set in a currently commonly used manner. Details are not described herein.

During specific application, the antenna 10 provided in embodiments of this application may be used in a communication device like a base station or a radar, to implement a wireless communication function.

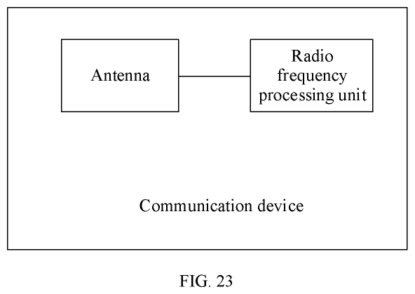

As shown in FIG. 23, the communication device may include a radio frequency processing unit, and the radio frequency processing unit may be connected to a feed network of the antenna. The radio frequency processing unit may be configured to: perform frequency selection, amplification, and down-conversion on a signal received by the antenna, convert the signal into an intermediate frequency signal or a baseband signal, and send the intermediate frequency signal or the baseband signal to the baseband processing unit. Alternatively, the radio frequency processing unit is configured to: perform up-conversion and amplification on an intermediate frequency signal sent by the baseband processing unit, convert the intermediate frequency signal into a radio signal, and send the radio signal through the antenna. The baseband processing unit may be connected to the feed network of the antenna through the radio frequency processing unit. In some implementations, the radio frequency processing unit may also be referred to as a remote radio unit (remote radio unit, RRU), and the baseband processing unit may also be referred to as a baseband unit (baseband unit, BBU).

It should be noted that, in practice, a specific type of the communication device and components included in the communication device may be properly selected and adjusted based on an actual situation. A specific type of the communication device is not limited in this application.

In various embodiments of this application, unless otherwise stated or there is a logic conflict, terms and/or descriptions in different embodiments are consistent and may be mutually referenced, and technical features in different embodiments may be combined into a new embodiment based on an internal logical relationship thereof.

“A plurality of” in this application means two or more than two. The term “and/or” describes an association relationship between associated objects and indicates that three relationships may exist. For example, A and/or B may indicate the following cases: Only A exists, both A and B exist, and only B exists. A and B may be singular or plural.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. An antenna array structure, comprising a reflection plate, a first element, and a first parasitic structure, wherein:
the reflection plate has a reflective surface;
the first element is disposed on a side of the reflective surface; the first parasitic structure is disposed on a side of the reflective surface and coupled to the first element; and
vertical projections of the first parasitic structure and the first element on the reflective surface do not overlap, and a distance between the first parasitic structure and the first element is greater than or equal to 1/4λ, wherein λ is a wavelength in space of an electromagnetic wave radiated by the first element at the lowest frequency.

2. The antenna array structure according to claim 1, wherein the distance between the first parasitic structure and the first element is less than or equal to 3/4λ.

3. The antenna array structure according to claim 1, wherein the first element and the first parasitic structure are located in a same plane, and the plane is parallel to the reflective surface.

4. The antenna array structure according to claim 1, wherein:
the antenna array structure comprises a plurality of elements and a plurality of parasitic structures; and
the plurality of elements are coupled to the plurality of parasitic structures in a one-to-one correspondence.

5. The antenna array structure according to claim 1, wherein:
the antenna array structure comprises a plurality of elements;
the plurality of elements comprise the first element and a second element, and the second element is an element adjacent to the first element; and
the first parasitic structure is located on a periphery of the second element.

6. The antenna array structure according to claim 5, wherein the second element and the first parasitic structure form an integral structure.

7. The antenna array structure according to claim 5, wherein:
the antenna array structure further comprises a second parasitic structure; and
the second parasitic structure is coupled to the second element, and the second parasitic structure is located on a periphery of the first element.

8. The antenna array structure according to claim 7, wherein the first element and the second parasitic structure form an integral structure.

9. The antenna array structure according to claim 1, wherein an equivalent electrical length of the first parasitic structure is greater than 1/2λ.

10. The antenna array structure according to claim 1, wherein:
the first element comprises a first radiating arm and a second radiating arm, and the first radiating arm and the second radiating arm are disposed orthogonally;
the first parasitic structure comprises a first coupling arm and a second coupling arm, and the first coupling arm and the second coupling arm are disposed orthogonally; and
the first coupling arm is coupled to the first radiating arm, and the second coupling arm is coupled to the second radiating arm.

11. The antenna array structure according to claim 10, wherein the first parasitic structure is cross-shaped, and the first coupling arm and the second coupling arm are disposed orthogonally, wherein an included angle between the first radiating arm and the first coupling arm is 0° or 45°.

12. The antenna array structure according to claim 10, wherein the first parasitic structure is a rectangular frame, a portion of sides of the rectangular frame forms the first coupling arm, and another portion of sides forms the second coupling arm.

13. An antenna, comprising a feed network and an antenna array structure, wherein the antenna array structure comprises a reflection plate, a first element, and a first parasitic structure, wherein the feed network is electrically connected to the first element for feeding, wherein:
the reflection plate has a reflective surface;
the first element is disposed on a side of the reflective surface;
the first parasitic structure is disposed on a side of the reflective surface and coupled to the first element; and
vertical projections of the first parasitic structure and the first element on the reflective surface do not overlap, and a distance between the first parasitic structure and the first element is greater than or equal to 1/4λ, wherein λ is a wavelength in space of an electromagnetic wave radiated by the first element at the lowest frequency.

14. The antenna according to claim 13, wherein the distance between the first parasitic structure and the first element is less than or equal to 3/4λ.

15. The antenna according to claim 13, wherein the first element and the first parasitic structure are located in a same plane, and the plane is parallel to the reflective surface.

16. The antenna according to claim 13, wherein:
the antenna array structure comprises a plurality of elements and a plurality of parasitic structures; and
the plurality of elements are coupled to the plurality of parasitic structures in a one-to-one correspondence.

17. The antenna according to claim 13, wherein:
the antenna array structure comprises a plurality of elements;
the plurality of elements comprise the first element and a second element, and the second element is an element adjacent to the first element; and
the first parasitic structure is located on a periphery of the second element.

18. The antenna according to claim 17, wherein the second element and the first parasitic structure form an integral structure.

19. The antenna according to claim 17, wherein:
the antenna array structure further comprises a second parasitic structure; and
the second parasitic structure is coupled to the second element, and the second parasitic structure is located on a periphery of the first element.

20. The antenna according to claim 19, wherein the first element and the second parasitic structure form an integral structure.
